(19) United States
(12) Patent Application Publication
(10) Pub. No.: US 2015/0115552 A1
(43) Pub. Date: Apr. 30, 2015

(54) MAGNETIC CHUCK

(71) Applicant: JIN YOUNG PRECISION MACHINE CO., LTD., Gyeonggi-do (KR)

(72) Inventors: Yong Goo Lee, Gyeonggi-do (KR); Jong Suk Lee, Gyeonggi-do (KR); Jong Min Lee, Gyeonggi-do (KR)

(21) Appl. No.: 14/388,185

(22) PCT Filed: Mar. 6, 2013
(86) PCT No.: PCT/KR2013/001820

§ 371 Date: Sep. 25, 2014

(30) Foreign Application Priority Data
Mar. 26, 2012 (KR) 10-2012-0030670

(51) Int. Cl. B23Q 3/154; H01F 7/02

(52) U.S. Cl. CPC B23Q 3/1546; H01F 7/02
USPC 279/128

(57) ABSTRACT

A magnetic chuck comprising: a lower plate to which a conductive magnetic body for fixing one side of a warped workpiece by magnetic force is coupled; a main body made of a magnetic material and an open side of which has an accommodation groove for insertion of insulating means, the main body being fixed at the lower plate; insulating means inserted into the accommodation groove of the main body and embedded with an insulating coil and an Alnico magnet on the interior thereof, the insulating means being configured to induce a magnetic line of force to flow only through the Alnico magnet to thus provide strong fixing force for the workpiece through the magnetic chuck; and a support member arranged on an upper portion of the main body to be attached to the other side of the workpiece through the magnetic field of the Alnico magnet. The magnetic line of force flowing from the magnetic chuck is permitted to flow only at both ends of the workpiece so that a grinding and cutting process for maintaining the flatness of the workpiece is enabled while maintaining the shape of the warped workpiece, thus enabling surface processing even at the state where the warped surface of the workpiece is maintained.

### BACKGROUND

This report is about invention of a magnetic chuck. More precisely, about invention of a magnetic chuck that can operate by making the magnetic line from the magnetic chuck flow only at both ends of workpiece to enable you to grind the workpiece to maintain its warped shape and the smoothness of its surfaces, and you can process the surfaces even while maintaining the workpiece's warped surfaces. Also, you can precisely process the workpiece's flat surfaces and right angles and the right angles of both its sides without using a separate jig, and you can process the workpiece in various other ways such as processing of any angles or round bars by using a simple jig. Moreover, since power is supplied only when the workpiece is attached on the magnetic chuck, you can save electricity, and you can safely process the workpiece while it attached even when the power supply cable is disconnected.

FIG. 1 is a drawing of a conventional magnetic chuck.

As shown in the drawing, a conventional magnetic chuck is formed of an insulated coil in the receiving groove (102) of the main body (100), with a core (120) composed of alnico or an iron core inserted and the power connection part of the insulated coil coupled to the power and consequently coupled to the electric wire (122) from the outside power supply.

Moreover, after filling up and curning the receiving groove (102) on the main body (100) with a liquefied filling material (140), such as the macromolecule synthetic resin of an insulation-nonmagnetic material, the magnetic chuck will be comprised of the main body (100) and the top plate (160) by the coupling member.

By supplying the power through the power supply line (122) in accordance with the conventional magnetic chuck, the core (120) arranged at the center of an insulating coil will be magnetized, and the polarity will be achieved.

However the conventional magnetic chuck has a problem as below. While the magnetic panel and the coupling panel of the top plate are facing the main body's both side rimes and the partition and the core, a non-magnetic stripe (166) should be firmly formed between the front and rear rim of the main body (100) and the top plate (160) in order to achieve the opposite polarity per each position. Also, it is necessarily to block the magnetic field for non-direct contacting and, therefore, more components were needed, resulting in more process stages.

Furthermore, magnetic (162) and non-magnetic substances (164) are laminated between the coupling panels (164), the coupling is made by nuts and bolts and the milling and grinding processes are performed for all six planes, and then finally it is coupled to the lower structure (100). By this complicated structure composition, conventional magnetic chucks have problems with expensive cost of the production and the maintenance.

In addition, production costs of conventional magnetic chucks are high due to the difficulty of manufacturing and the waste of the material resulting from the cutting process for complex structures of the main body (100), such as the receiving groove (102) and the wiring connection hole.

Moreover, since conventional magnetic chucks' receiving grooves (102) are sealed by the rim and the circumferential surface of the partition (112), it is difficult to separate a filling material (140), and the core (120) and the insulated coil (100) embedded in each magnetic chuck in order to recycle it.

In addition, if you operate a conventional magnetic chuck (100) to fix a workpiece on the base of the top plate (160), the magnetic field is generated only on the top plate (160) and the workpiece can only be fixed on the top plate. As a result, you cannot provide magnetic chucks that meet various processing conditions such as workpiece types.

In particular, in case of warped workpieces, the workpiece itself can cause a variation while it sticks to the base surface of the top plate (160) completely like a plane by a magnetic field. Also, if the operation of the magnetic chuck is interrupted after finishing the smoothening process through grinding, the smoothening process would not be made precisely due to the restoration of the warped workpiece.

Hence, it is extremely difficult to maintain the warped shape of the narrow gap of the bottom surface keep the flatness of the warped workpiece through support by the magnetic force, to keep the smoothness of the warped workpiece. As a result, the supporting jig or supporting tool needed to be installed separately, causing an increase in the work process.

### SUMMARY OF THE INVENTION

To solve these challenges, this report has been written to provide a magnetic chuck that can operate by making the magnetic line from the magnetic chuck flow only at both ends of workpiece to enable you to grind the workpiece to maintain its warped shape and the smoothness of its surfaces, and you can process the surfaces even while maintaining the workpiece's warped surfaces. Also, you can precisely process the workpiece's flat surfaces and right angles and the right angles of both its sides without using a separate jig, and you can precisely process right angles or round bars of hexahedrons, as well as any angles to the x-axis or the y-axis.

This invention, developed to solve these challenges, is a magnetic chuck comprising of: a lower plate to which a magnetic conductor fixing one side of a warped workpiece by magnetic force is coupled; a main body which is made of a magnetic material, has an open side with a receiving groove in which the insulator will be inserted, and is fixed to the said lower plate; an insulator which is inserted into the receiving groove of the said main body, is embedded with an insulating coil and an alnico magnet, and provides a strong fixing force for the workpiece; and a support member which is attached to the upper part of the said main body through the other side of the workpiece and the alnico magnet's magnetic field.

In this invention, the said insulator is made of the artificial stone and marble produced using epoxy granite and is embedded with an insulating coil and alnico magnet.

In this invention, the said support member is fixed and coupled using the fastener composed of the magnetic conductor on one side of the insulator and facilities changing the locations of the magnetic chuck, even the undersurface of the magnetic chuck is adhesive by magnetism. So the magnetic chuck characterized by easy position change of the magnetic chuck or easy position change to the processing side of a workpiece.

In this invention, the main body and the lower plate is fixed and coupled with the fixing bolt after forming multiple coupling holes in the one side and insulator is inserted between the other side surface formed vertical bending main body, ultimately magnetic chuck characterized by whole six plane surface processing such as a magnetic chuck, the back, the left and right sides, a flat, lower plate and upper plate.

In this intervention, the above magnetic chucks are installed at a certain interval from the lower plate and are installed in the opposite direction to each other. Here, using the workpiece as the intermediary, the magnetic chuck of one side and the magnetic chuck of the other side are magnetized and the workpiece is attached.

In this intervention, the insulator is placed between the perpendicular plate and the lower plate of the main body to form a magnetic field around the workpiece. On the perpendicular plate, the magnetic chuck is adhered with the magnetic force with which the securing jig are installed.

In this intervention, the magnetic chuck in which the supporting unit supporting the lower plate of the workpiece in which magnetic chuck unitizes the phloem screwing the drawing itself in one side of the insulator through the fastener and the drawing itself, and the drawing itself is generated that it forms the insertion hole on the upper portion of the drawing itself and this main body and the upper portion bends are inserted.

In this intervention, the magnetic chuck supporting the inside center part of the workpiece in which it inserts the connection intermediary so that supporting unit be the magnetic field generated from the alnico magnet to the artifact side the drawing person so that the workpiece be adhered to the magnetic chuck, and the magnetic field is generated to the base block in which the fixing groove in which the supporting unit is inserted and fixed in the magnetic chuck is formed comprised and bent.

This invention also relates to the magnetic chuck characterized steel sheet coupling between the main body, the lower plate and the insulator.

Hence, this invention a magnetic chuck that can operate by making the magnetic line from the magnetic chuck flow only at both ends of workpiece to enable you to grind the workpiece to maintain its warped shape and the smoothness of its surfaces, and you can process the surfaces even while maintaining the workpiece's warped surfaces. Also, you can precisely process the workpiece's flat surfaces and right angles and the right angles of both its sides without using a separate jig, and you can precisely process right angles or round bars of hexahedrons, as well as any angles to the x-axis or the y-axis.

### BRIEF DESCRIPTION OF THE DRAWINGS

FIG. 1 is a cross-sectional view illustrating a conventional magnetic chuck.

FIGS. 2 to 4 are perspective views illustrating the magnetic chuck in accordance with Working Example 1 of this invention.

FIGS. 5 to 7 are cross-sectional views illustrating a main part of the magnetic chuck in accordance with Working Example 1 of this invention.

FIG. 8 is a view illustrating the magnetic chuck in accordance with Working Example 2 of this invention.

FIGS. 9a to 9c are views illustrating states in which the workpiece is held with more than one magnetic chuck in accordance with Working Example 2 of this invention.

FIGS. 10 and 11 are views illustrating the magnetic chuck in accordance with Working Example 3 of this invention.

FIGS. 12 and 13 are views illustrating the magnetic chuck in accordance with Working Example 4 of this invention.

FIG. 14 to 17 are views illustrating the magnetic chuck in accordance with Working Example 5 of this invention.

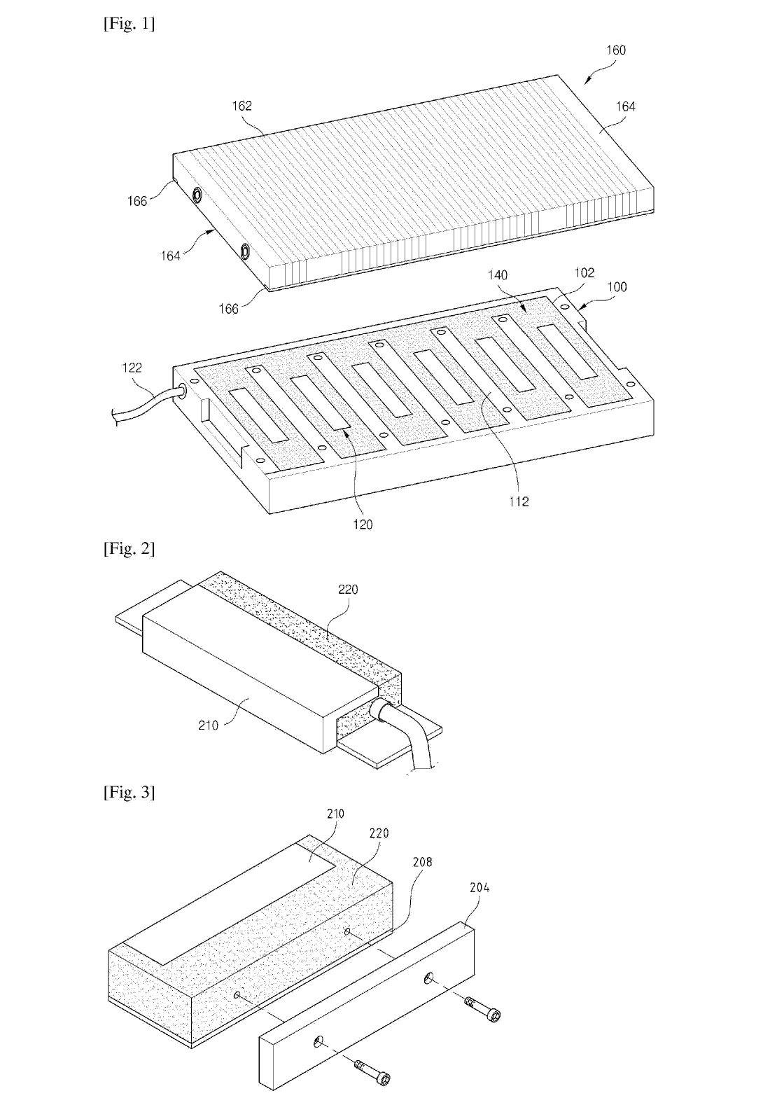

### DETAILED DESCRIPTION OF THE INVENTION

A lower plate to which a magnetic conductor fixing one side of a warped workpiece by magnetic force is coupled; a main body which is made of a magnetic material, has an open side with a receiving groove in which the insulator will be inserted, and is fixed to the said lower plate; an insulator which is inserted into the receiving groove of the said main body, is embedded with an insulating coil and an alnico magnet, and provides a strong fixing force for the workpiece; and a support member which is attached to the upper part of the main body through the other side of the workpiece and the alnico magnet's magnetic field.

Hereinafter, the ideal working examples of this invention will be described in detail with reference to the accompanying drawings. Like reference numbers designate like elements throughout the specification. Further, detailed descriptions of well-known functions and structures incorporated herein may be omitted to avoid obscuring the subject matter of this document

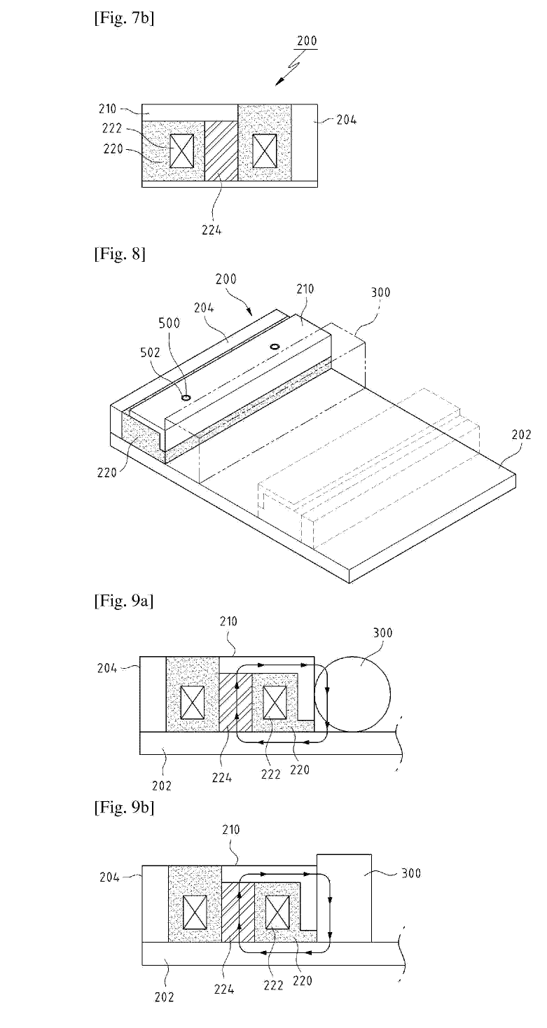

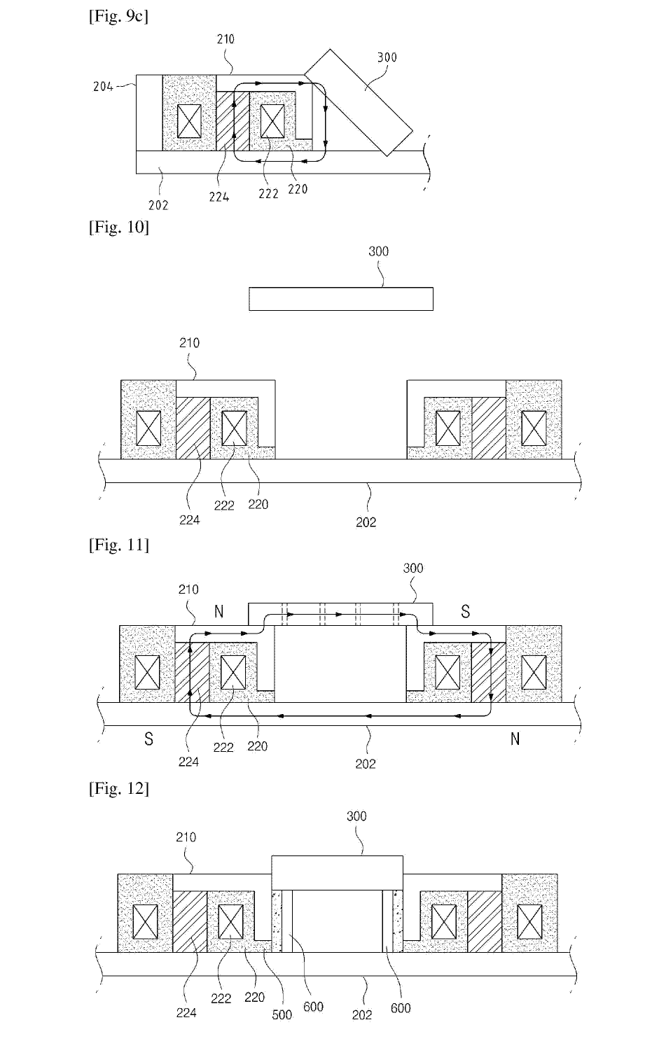

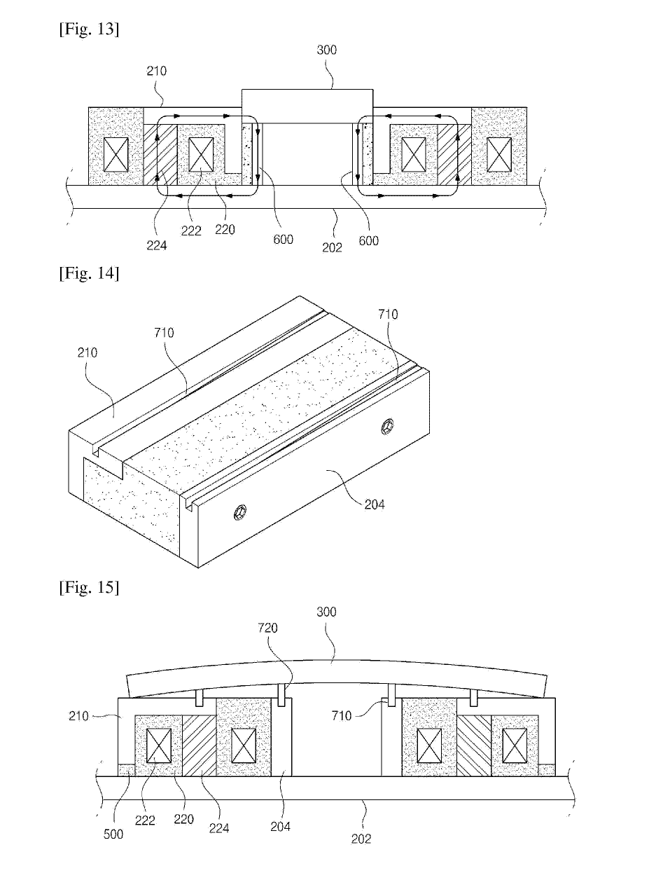

FIGS. 2 to 4 are perspective views illustrating the magnetic chuck in accordance with Working Example 1 of this invention. FIGS. 5 to 7 are cross-sectional views illustrating a main part of the magnetic chuck in accordance with Working Example 1 of this invention. FIG. 8 is a view illustrating the magnetic chuck in accordance with Working Example 2 of this invention. FIGS. 9a to 9c are views illustrating states in which the workpiece is held with more than one magnetic chuck in accordance with Working Example 2 of this invention. FIGS. 10 and 11 are views illustrating the magnetic chuck in accordance with Working Example 3 of this invention. FIGS. 12 and 13 are views illustrating the magnetic chuck in accordance with Working Example 4 of this invention. FIG. 14 to 17 are views illustrating the magnetic chuck in accordance with Working Example 5 of this invention.

As shown in the figure, the magnetic chuck (200) according to the first preferred embodiment of the present invention may comprise the main body (210) in which the receiving groove the insulator (220) is inserted is formed, the insulated coil (222) in the inner portion and alnico magnet (224) one side is adopted to the main body (210) built-in insulator (220), and the steel sheet (208) which is comprised in the other side of the insulator (220) and the other side is fixed to the insulator (220) one side to the bolt and the bolt is comprised in the lower part of the magnetic chuck (200) and the supporting member (204) consisting of the magnetic material so that one side of the workpiece be fixed with the magnetic force and is comprised between the main body (210), and the insulator (220) and lower plate (202).

The receiving groove is manufactured to the material of the magnetic material the insulator (220) is inserted and one side is admitted are formed at the main body (210).

It is fixed to and combined with the fastener like lower plate (202) and anchoring bolt (not illustrated) which are this main body (210) is the magnetic material in the lower part. And it is configured to prevent from the surface heat treatment being made and scratch due to the contact with the workpiece taking place.

Further, on the upper portion of the main body (210), the magnetic conductor (230) is formed capable of fixing the one side surface of the workpiece by the magnetic force.

It is inserted into the receiving groove formed in the insulator (220) is the main body (210) and it is fixed. When the insulated coil (222) and alnico magnet (224) are installed at the inner portion and the external power supply is authorized to the insulated coil (222) it induces so that the alnico magnet (224) is magnetized and the line of magnetic force flow only through the alnico magnet (224) and the workpiece the strong adhesive force is provided through the alnico magnet (224), the main body (210), and the lower plate (202) with the magnetic force.

And it organizes on the artificial marble etc. to the conventional mode in which the insulator (220) of the present invention is hardened using the fluid resin. In that way manufactured through the epoxy granite, etc. the abrasion of the insulator (220) can be prevented. Also the damage including scratch etc. is minimized. The damage is generated due to the repetitive contact with the workpiece. Moreover, the maintenance of the planarity of the magnet chuck (200) upper side is facilitated according to have the intensity of the given or greater. It prevents from the processing liquid and the minute foreign substances from penetrating into the inner portion.

One side is fixed to adhere closely to the direction standing face to face with the supporting member (204) is the main body (210), in other words, one side of the insulator (220). And the lower part is fixed to and combined through the lower plate (202) and fastener. The magnetic chuck (200) is attached with the magnetic force in the lower plate (202) and table. If supporting the other side part of the workpiece the power source is applied in the insulated coil (222) and the magnetic field is formed from the alnico magnet (224) the line of magnetic force generates the fixing member (206) is configured to be combined through the anchoring bolt with the insulator (220) so that the other side part of the workpiece be adhered.

Here, as described in FIG. 3 the supporting member (204) is fixed to and combined with one side of the insulator (220) to be described below through the fastener and the portability of the magnetic chuck (200) can be improved.

In other words, the supporting member (204) is fixed to and combined with the insulator (220) and anchoring bolt in order to fix the magnetic chuck (200) to the lower plate (202) through the magnetic force. In that way it can be more conveniently the fixing of the workpiece made through the alnico magnet (224) with the flowing line of magnetic force according to be comprised of one assembly. Also the location shift about the processing surface of the location shift of the magnetic chuck (200) or the workpiece etc. can be made in the lower plate (202).

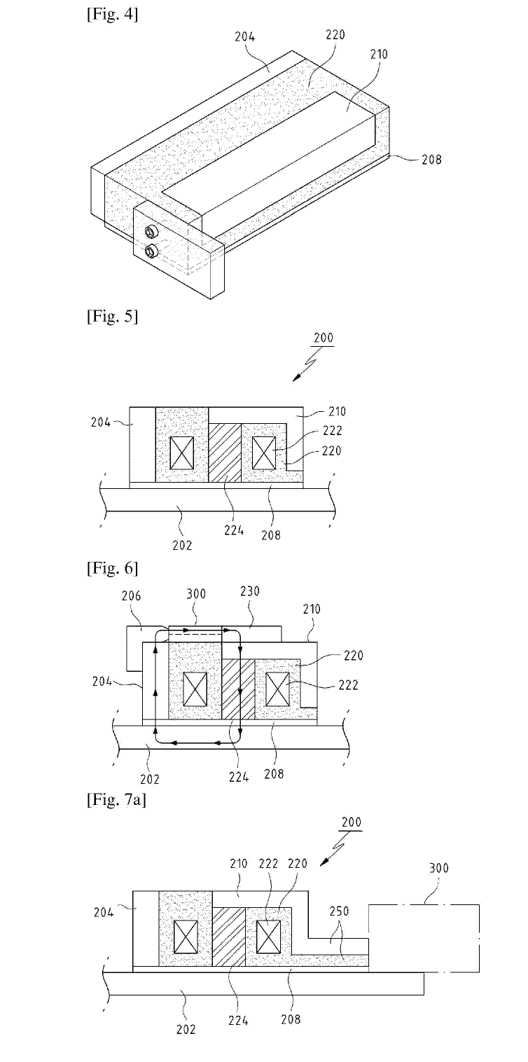

And as described in FIG. 4, the drawing itself (230) is comprised in one side of the insulator (220) through the anchoring bolt to be fixed to and combined. The squareness between the workpiece and the magnetic chuck (200) are easily maintained through 3-sided paper of drawing itself (230) bonded to the main body (210), and the lower plate (202) and insulator (220) this maintains the squareness of the workpiece positioned between one side and lower plate (202) of the main body (210).

It is connected to lower plate (202) configured in the lower part of the alnico magnet (224) in this alnico magnet (224) the alnico magnet (224) is magnetized after process 5 and the workpiece in which it is generated as described in FIG. 6, to bend the magnetic chuck (200) according to the first preferred embodiment of the invention settles this workpiece in the upper side of the magnetic chuck (200) power is permitted in the insulated coil (222) to fixing member (206) bonded to the lower plate (202), the supporting member (204) and this supporting member (204) the magnetic force flows back.

Thereafter, if the drawing itself (230) for fixing this workpiece to the upper side of the main body (210) with the workpiece is set up both sides of the workpiece in which the magnetic force is generated that it bends while the magnetic force flows back to the alnico magnet (224)→lower plate (202)→supporting member (204)→fixing member (206)→workpiece→drawing itself (230)→main body (210)→alnico magnet (224) net is fixed with the magnetic force. With maintaining the state where the workpiece of the state bending is bent the state is fixed and the processing is made. And with the tensile force to the magnet side being weak with the insulator (220) and maintaining the state of the workpiece bending the processing is made. And with maintaining the bent state of the workpiece after the processing the plane of the processing surface is like that maintained.

A magnetic chuck (200) is comprised so that the magnetic chuck (200) prevent when processing workpiece with high height one side is extended the magnetic chuck (200) according to the first preferred embodiment of the invention is extended and formed to one side of the insulator (220) and main body (210) as shown in 7a from the machine tool like the wire cut and magnetic chuck (200) colliding. That is, the workpiece is adhered with the magnetic force and the processing is comprised of the extension part (250) and lower plate (202).

As described in FIG. 7b, the effect including the manufacturing cost and cost reduction etc. the magnetic chuck (200) is manufactured the main body (210) is positioned in the upper plate of the insulator (220) and this main body (210) is fixed to and combined through the insulator (220) and anchoring bolt may be obtained.

Meanwhile, FIG. 8 is a view illustrating the magnetic chuck in accordance with Working Example 2 of this invention.

As shown in the figure, the magnetic chuck (200) according to the second preferred embodiment of the present invention comprises the supporting member (204) which is comprised in the main body (210), the insulated coil (222) in the inner portion and alnico magnet (224) one side is adopted to the main body (210) built-in insulator (220), and the other side of the insulator (220) and is made of the magnetic material so that one side of the workpiece be fixed with the magnetic force. And comprised of the main body (210) in which the lower plate (202) and the multiple combining holes (502) for fixing and combining are formed. As to the main body (210), the receiving groove the insulator (220) is inserted is formed.

That is, by fixing the combining hole (502) formed on main body (210) with the main body (210) and lower plate (202) through the anchoring bolt (510), the magnetic chuck (200) and lower plate (202) comprise into one body. The lower plate (202) is separated with this magnetic chuck (200). And the other magnetic chuck (200) in which the attaching whether or not is determined in the lower plate (202) according to the power on is organized and various processings will be possible.

In this way, as described in FIG. 9c, the lower plate (202) and the magnetic chuck (200) comprised into one body can maintain the squareness of FIG. 9a in the angle processing of the workpiece as well as the workpiece of the round rod.

That is, as described in FIG. 9a, it is the workpiece of the round rod positioned between one side and lower plate (202) of the main body (210). Power is permitted and it organizes so that the workpiece of the round rod be adhered to the magnetic chuck (200). In that way the round rod processing is made.

Moreover, as described in FIG. 9b, the right angle processing of the hexahedron of the workpiece and angle processing are possible. As described in FIG. 9c, the predetermined groove is formed on the main body (210) and lower plate (202) in especially, the angle processing. It is of course that various angle processings are possible according to the angle of this groove.

In the meantime, as described in FIGS. 10 and 11, in case the magnetic chuck (200) according to the third preferred embodiment of the present invention is the workpiece in which the drilling process is performed so that the penetration processing be made the magnetic chuck (200) of the present invention is set up in the direction faced with each other in the lower plate (202) and while the magnetization is made the magnetic chuck (200) of one side and magnetic chuck (200) of the other side of the magnetic field generated from the alnico magnet (224) can fix the workpiece the workpiece to the intermediary through the 2 magnetic chucks (200). While configured to building up the pole in which the 2 magnetic chucks (200) runs counter to each other. As shown in FIG. 11, the workpieces are attached to 2 magnetic chucks (200).

In addition, as described in FIGS. 12 and 13, the magnetic chuck (200) according to the fourth preferred embodiment of the present invention sets up in upper plate of table configured in the direction faced with each other the lower plate (202) and

machine tool. The securing jig (600) is set up so that the workpiece is settled in the perpendicular side of the main body (210) and the attaching be securely accomplished with the magnetic force. And it organizes so that the insulator (220) be positioned between this securing jig (600) and main body (210). In that way both sides of the workpiece the magnetic field flows and this workpiece can be fixed through the 2 magnetic chucks (200).

That is, as described in FIG. 13, the fixing of both sides of the workpiece the line of magnetic force flows to the alnico magnet (224)→main body (210)→workpiece→securing jig (600)→lower plate (202)→alnico magnet (224) net it has the plurality and power is permitted in the magnetic chuck (200) installed in the direction faced with each other are configured to be securely made with the magnetic force. And it can prevent from there being no influence of the magnetic field and the chip generated in the processing being adhered to the workpiece to the central part of the workpiece with the magnetic force.

In the meantime, as described in FIGS. 14 through 17, the insertion hole (710) in which the supporting unit (720) of the inclined surface is inserted is along the longitudinal direction formed longer than in the case where the magnetic chuck (200) according to the fifth preferred embodiment of the present invention is the supporting member (204) connected in the exposed side of the main body (210), and the insulator (220) fixed to and combined with this main body (210) with the fastener, and the top surface of the supporting member (204) and main body (210). And the top surface are formed.

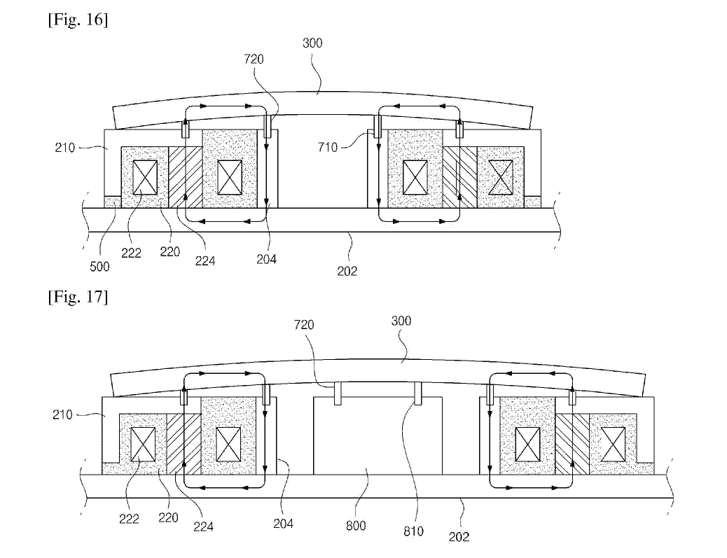

In other words, as described in FIGS. 15 and 16, the magnetic chuck (200) it installs in the direction faced in each other to the upper side of the lower plate (202) and the supporting unit (720) is positioned at the inner side are used as the connection intermediary which it connects when rotating of the artifact side the magnetic field the magnetic field which is generated from the alnico magnet (224) it supports the side of the workpiece in which it is generated it bends it fixes the supporting unit (720) on the insertion hole (710) formed on the main body (210) and supporting member (204) it sets up it controls the insertion location. And the workpiece is configured to be fixed to the magnetic chuck (200).

And as described in FIG. 17, in the magnetic chuck (200) of the present invention, the base block (800) is comprised. And the fixing groove (810) in which the supporting unit (720) is inserted and fixed is formed in this base block (800). In that way, the workpiece in which it is generated to bend in case the length of the workpiece crawls supports the central part of the inner surface and the workpiece can be steadily fixed to the magnetic chuck (200).

Hence, the magnetic chuck (200) of this invention is very useful in the way that it enables the grinding and cutting processes for maintaining the flatness of the workpiece while maintaining the shape of the warped workpiece. Hence, you can process the surface even at the state where the warped surface of the workpiece is maintained.

In addition, the reference number “300” unrecorded in this “Details of the invention” is the workpiece may be the drawing number.

The description described above illustratively explains the technical idea of the present invention it is nothing but. If it grows up under the technical field in which the invention belongs the various corrections and deformation will be available in the range that it does not deviate from the intrinsic property of the present invention. Therefore, it is not but limits the technical idea of the present invention embodiment disclosed in the inventions are to explain. The range of the technical idea of the present invention is not limited by this embodiment. All technical ideas within that and the equivalent range it has to be interpreted are included in the scope of protection of the present invention and the scope of protection of the present invention should be interpreted by the following claims.

This invention a magnetic chuck that can operate by making the magnetic line from the magnetic chuck flow only at both ends of workpiece to enable you to grind the workpiece to maintain its warped shape and the smoothness of its surfaces, and you can process the surfaces even while maintaining the workpiece's warped surfaces. Also, you can precisely process the workpiece's flat surfaces and right angles and the right angles of both its sides without using a separate jig, and you can precisely process right angles or round bars of hexahedrons, as well as any angles to the x-axis or the y-axis.

<Reference Numerals>

| | |
|---|---|
| 202: Lower plate | 204: Conductive magnetic body |
| 210: Main body | 220: Insulator |
| 222: Insulated coil | 224: Alnico magnet |
| 230: Support member | 300: Workpiece |
| 510: Fixing bolts | 600: Fixed jig |
| 710: Inserting groove | 720: Supporting means |
| 800: The base block | 810: Fixing groove |

What is claimed is:

1. A magnetic chuck, comprising;
a lower plate to which a magnetic conductor fixing one side of a warped workpiece by magnetic force is coupled;
a main body which is made of a magnetic material, has an open side with a receiving groove in which the insulator will be inserted, and is fixed to the lower plate;
an insulator which is inserted into the receiving groove of the main body, is embedded with an insulating coil and an alnico magnet, and provides a strong fixing force for the workpiece; and
a support member which is attached to the upper part of the main body through the other side of the workpiece and the alnico magnet's magnetic field.

2. The magnetic chuck of claim 1, wherein the insulator is made of the artificial stone and marble produced using epoxy granite and is embedded with an insulating coil and alnico magnet.

3. The magnetic chuck of claim 1, wherein the support member is fixed and coupled using the fastener composed of the magnetic conductor on one side of the insulator and facilitates changing the locations of the magnetic chuck, or the workpiece on the processed surface.

4. The magnetic chuck of claim 1, wherein the main body and the said lower plate are fixed and coupled with the fixing bolts after forming multiple coupling holes on one side of each of them, and the magnetic conductor is attached to the insulator using fixing bolts is inserted between the other side surface formed vertical bending main body, and all six plane surfaces, including the magnetic chuck, the back, the left and right sides, the flat, lower and upper plates, can be processed.

5. The magnetic chuck of claim 1, wherein two of the magnetic chucks are attached to the lower plate, spaced apart at a regular interval and in opposite directions of each other, and the magnetic chuck on one side and the magnetic chuck on the other side are magnetized through magnetic conduction and by using the workpiece as a medium, and the workpiece is attached and processed.

6. The magnetic chuck of claim 5, wherein the insulator is attached between the main body's perpendicular surface and the lower plate so that magnetic field only forms on the two side of the workpiece, and a fixing jig is placed so that the workpiece can be attached by the magnetism to this perpendicular surface.

7. The magnetic chuck of claim 5, wherein the magnetic chuck integrates the main body and the magnetic conductor by tightening the fastener to one side of the insulator, and the support member which will support the lower plate of the warped workpiece by forming an insertion groove at the tops of the main body and the magnetic conductor.

8. The magnetic chuck of claim 7, wherein the support member is used to insert a connecting medium so that the magnetic field created by the alnico magnet is exerted toward the workpiece, in order to attach the workpiece to the magnetic chuck, the magnetic chuck has a base block with a fixing groove in which the support member will be inserted and fixed, and the base block will support the internal center of the warped workpiece.

9. The magnetic chuck of claim 1, wherein steel sheets are inserted between the main body, the insulator and the lower plate, in the lower part of the said magnetic chuck.

10. The magnetic chuck of claim 1, wherein the magnetic chuck is connected to one side of the said main body and the insulator to be extended as a single object, which will enable creation of an extended part facilitating processing high workpieces.
